(19) United States
(12) Patent Application Publication
(10) Pub. No.: US 2017/0310615 A1
(43) Pub. Date: Oct. 26, 2017

(54) Reconjugating User Social Profile Attributes into Conversational Prompts

(71) Applicant: Google Inc., Mountain View, CA (US)

(72) Inventor: Sara Su, Mountain View, CA (US)

(73) Assignee: Google Inc., Mountain View, CA (US)

(21) Appl. No.: 14/260,499

(22) Filed: Apr. 24, 2014

(51) Int. Cl. H04L 12/58

(52) U.S. Cl. CPC H04L 51/046

(57) ABSTRACT

This disclosure presents a system, methods, and software for using elements of social network objects associated with a user to prompt the user to engage in other activities on a social networking site. A system receives a plurality of social network content items associated with a user. The system stores the plurality of social network content items using one or more data stores. The system analyzes the plurality of social network content items associated with the user to determine an element of the plurality of social network content items for use in creating a personalized input prompt to encourage the user to interact with a social network. The system generates one or more personalized descriptors based on the element of the plurality of social network content items. The system transmits the one or more personalized descriptors to a client device for presentation by a client application.

### BACKGROUND

Social networking sites have the basic unit of the user profile, the online representation of each user. The attributes of the user profile differ depending on use cases and goals of the site, but most profiles serve to create an online identity of a real-world person. The more attributes a profile has, the better the in-product experience is for the user. Concretely, a more completely filled out profile enables other users to discover the profile more easily and the site to customize the product experience algorithmically based on the user's stated interests or interests learned by the social networking site based on user activity.

It can be difficult to obtain profile attributes for some users. For example, some users, after initially filling out their profiles, do not regularly post status updates on the social networking site, comment on other user's posts, or otherwise actively engage with the site. This may occur for many reasons. For instance, a user may not understand how to use the product or platform, the user may not find content on the site interesting, or the user may have writer's block and not know what content to post. As a result, such users have a poor user experience and eventually stop using the site.

Several social networking sites directly prompt users to till out key attributes missing from their profiles. For example, a site may prompt users to upload a profile image. Similarly, a site may display a “percentage complete” rating to each user.

### SUMMARY

According to one embodiment of the subject matter described in this disclosure, a system receives a plurality of social network content items associated with a user. The system stores the plurality of social network content items using one or more data stores. The system analyzes the plurality of social network content items associated with the user to determine an element of the plurality of social network content items for use in creating a personalized input prompt to encourage the user to interact with a social network. The system generates one or more personalized descriptors based on the element of the plurality of social network content items. The system transmits the one or more personalized descriptors to a client device for presentation by a client application.

In general, another innovative aspect of the subject matter described in this disclosure may be embodied in methods that include generating, by one or more processors, a social network interface for presentation to a user through a client application running on a client device, the social network interface including an input prompt; receiving one or more personalized descriptors, wherein the one or more personalized descriptors are based on social network content items associated with the user; generating, by the one or more processors, a personalized input prompt using the one or more personalized descriptors for presentation as part of the social network interface; and presenting the social network interface including the personalized input prompt to the user.

Other implementations of one or more of these aspects include corresponding systems, apparatus, and computer programs, configured to perform the actions of the methods, encoded on computer storage devices.

These and other implementations may each optionally include one or more of the following features. For instance the system may further: in response to the presentation of the personalized input prompt, receive an input representing a social network content item to be posted to the social network; update a social network profile associated with the user based on the input; generate the one or more personalized descriptors by combining the element of the plurality of social network content items with additional information; access a data structure including a corpus of semantically interrelated data; retrieve data related to the element of the plurality of social network content items; generate one or more personalized descriptors based on the data related to the element of the plurality of social network content items; and repeatedly generate one or more additional personalized descriptors based one or more additional elements of the plurality of social network content items and transmit the one or more additional personalized descriptors to a client device for presentation by the client application.

### BRIEF DESCRIPTION OF THE DRAWINGS

This disclosure is illustrated by way of example, and not by way of limitation in the figures of the accompanying drawings in which like reference numerals are used to refer to the same or similar elements.

FIG. 1 illustrates a block diagram of an example system for using elements of social network object associated with a user to prompt the user to engage in other activities on a social networking site.

FIG. 2 is a block diagram illustrating an example of a client device including a client device.

FIG. 3 is a block diagram illustrating an example of a client device including a client device.

FIG. 4 is a flowchart depicting an example method for presenting a personalized input prompt to a user.

FIG. 5 is a flowchart depicting an example method for presenting a personalized input prompt based on data semantically related to elements of social network objects associated with a user.

FIG. 6 is a flowchart depicting an example method for presenting a personalized input prompt for display to a user on a client device.

FIG. 7 is an example graphic representation of a social network interface including a personalized input prompt.

FIG. 8 is an example graphic representation of a social network interface after receiving an input based on a personalized input prompt.

### DETAILED DESCRIPTION

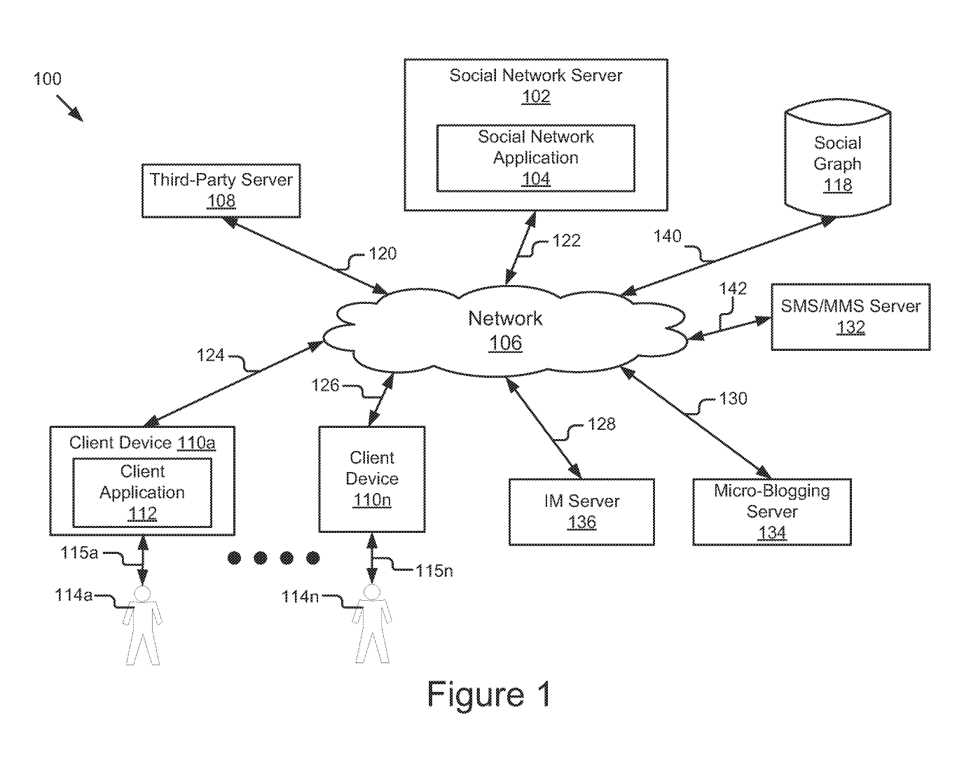

FIG. 1 illustrates a block diagram of a system 100 for using elements of social network objects associated with a user to prompt the user to engage in other activities on a social networking site. The illustrated system 100 includes a social network server 102 including a social network application 104, a network 106, a third-party server 108, one or more client devices 110a-110n (also referred to individually and/or collectively as 110) that are accessed by one or more users 114a-114n (also referred to individually and/or collectively as 110), a social graph 118, a Short Messaging Service (SMS)/Multi-media Messaging Service (MMS) sever 132, a micro-blogging server 134 and an Instant Messaging (IM) server 136 As illustrated, these entities may be communicatively coupled to the network 106 for interaction with one another. For example, the client devices 110a, 110n, the social network server 102, the third-party server 108, the social graph 118, the SMS/MMS sever 132, the micro-blogging server 134 and the IM server 136 are coupled to the network 106 via signal lines 124, 126, 122, 120, 140, 142, 130 and 128, respectively. It should be understood that any number of networks may be coupled to the above mentioned entities. The use of the nomenclature “a” and “n” in the reference numbers indicates that the system 100 may include any number of those elements having that nomenclature.

It should be understood that the system 100 illustrated in FIG. 1 is representative of an example system for using attributes in a user's profile to prompt the user to engage in other activities on a social networking site, and that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the system may he integrated into to a single computing device or system or additional computing devices or systems, etc.

The network 106 may include any number and/or type of networks, and may he representative of a single network or numerous different networks. For example, the network 102 may include, but is not limited, to, one or more local area networks (LANs), wide area networks (WANS) (e.g., the Internet), virtual private networks (VPNs), mobile (cellular) networks, wireless wide area network (WWANs), WiMAX® networks, Bluetooth® communication networks, various combinations thereof, etc.

The client devices 110a . . . 110n are computing devices having data processing and communication capabilities. In some implementations, a client device 110 may include a processor (e.g., virtual, physical, etc.), a memory, a power source, a communication unit, and/or other software and/or hardware components, including, for example, a display, graphics processor, wireless transceivers, keyboard, camera, sensors, firmware, operating systems, drivers, various physical connection interfaces (e.g., USB, HDIVII, etc.). The client devices 110a . . . 110n may couple to and communicate with one another and the other entities of the system 100 via the network 106 using a wireless and/or wired connection.

Examples of client devices 110 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two or more client devices 110 are depicted in FIG. 1, the system 100 may include any number of client devices 110. In addition, the client devices 110a . . . 110n may be the same or different types of computing devices.

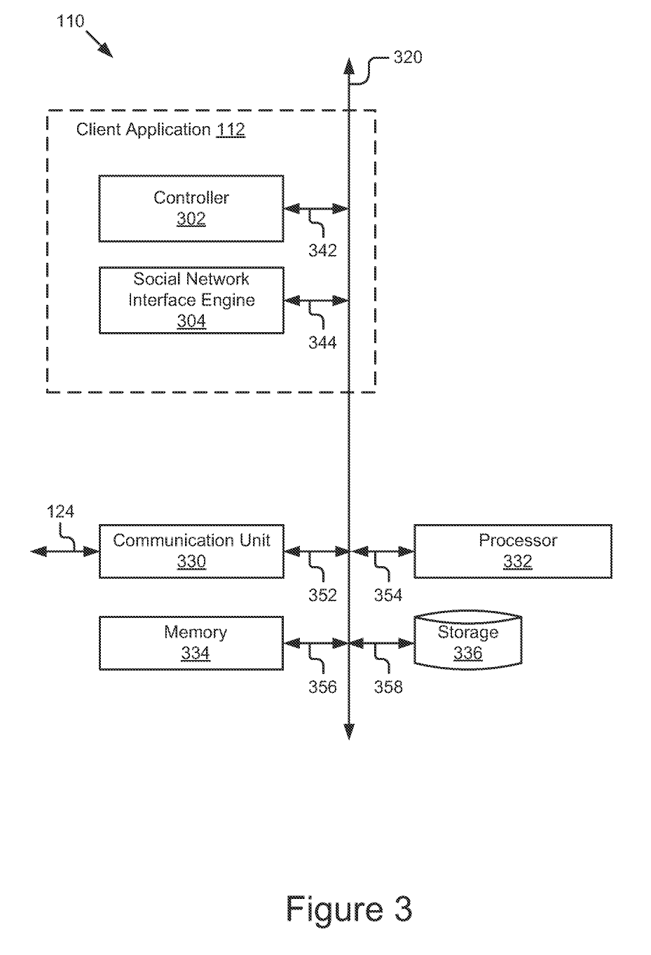

In the depicted embodiments, the client device 110 may include an instance of a client application 112. The client application 112 may be storable in a memory (not shown) and executable by a processor (not shown) of a client device 110. The client application 112 may include a browser application (e.g., web browser, dedicated app, etc.) that can retrieve, store, and/or process information hosted by one or more entities of the system 100 (for example, the social network server 102, the third-part) server 108, the micro-blogging server 134) and present the information on a display device (not shown) on the client device 110. The client application 112 is explained in further detail below with reference to FIG. 3.

The social network server 102 includes a social network application 104 that can generate and manage a social network. A social network can be any type of social structure where the users are connected by common features. The common features may include friendship, family, work, an interest, etc. The common features may he provided by one or more social networking systems, for example those included in the system 100, including explicitly-defined relationships and relationships implied by social connections with other online users 114, where the relationships form a social graph 118 in some examples, the social graph 118 reflects a mapping of these users 114 and how they are related.

The social network application 104 can receive information (for example, a username, password, demographic information, interests, etc.) from a user 114a and register the user 114a with the social network by generating a user profile and updating the social graph 118 of the user's relationship with other users 114n. The social network application 104 can also receive a request for social network content submitted by a user 114a from the client device 110a. In some cases, the social network application 104 retrieves social network content of the user 114a from the social network server 102, the social graph 118, the micro-blogging server 134, the 1M server 136, etc. and provides it to the client device 110a. The social network content may include, for example, a description of activities performed by the user 114a and the user's friends 114n, posts (for example, news articles, photos, videos, etc.) submitted by the user 114a and the user's friends 114n, conversations, events, etc.

The social network server 102, the third-party server 108, the micro-blogging server 134, the SMS/MMS server 132 and the 1M server 136 are, in some embodiments, hardware servers including a processor, memory and network communication capabilities. While only one social network server 102, third-party server 108, social graph 118, micro-blogging server 134, SMS/MMS 132 server, and IM server 136 are illustrated, any number of these entities may be present and coupled to the network 106. For example, the system 100 may include a first social network server and a first social graph directed towards business networking and a second social network server and a second social graph directed towards dating, etc.

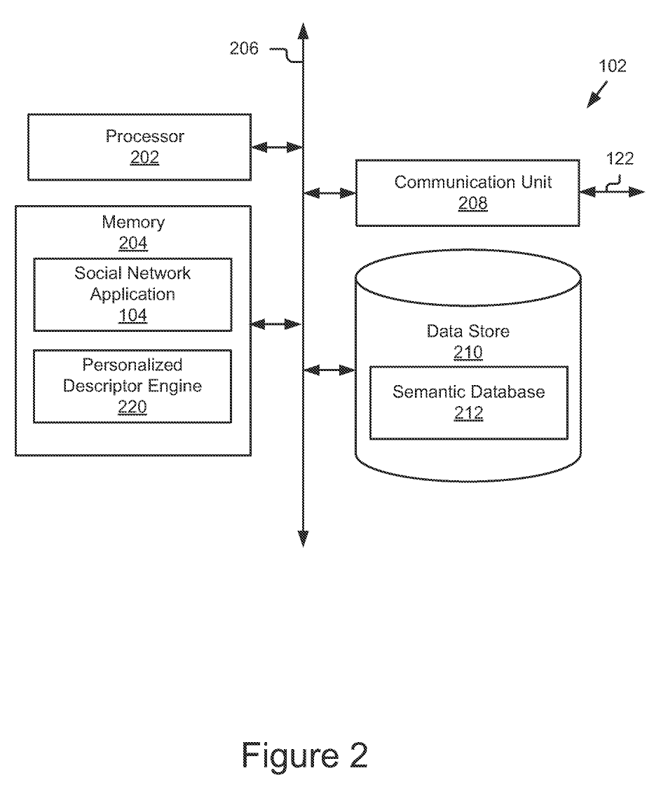

FIG. 2 is a block diagram of an example social network server 102. As depicted, the social network server 102 may include a processor 202, a memory 204, a communication unit 208, and a data store 210, which may be communicatively coupled by a communication bus 206. The social network server 102 depicted in FIG. 2 is provided by way of example and it should be understood that it may take other forms and include additional or fewer components without departing from the scope of the present disclosure. For instance, various components of the social network server 102 may reside on the same or different computing devices and may be coupled for communication using a variety of communication protocols and/or technologies including, for instance, communication buses, software communication mechanisms, computer networks, etc.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single processing unit or a plurality of processing units and/or cores. In some implementations, the processor 202 may be capable of generating and providing electronic display signals to a display device (not shown), supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the social network server 102 including, for example, the memory 204, the communication unit 208, and the data store 210.

The memory 204 may store and provide access to data to the other components of the social network server 102. The memory 204 may be included in a single computing device or a plurality of computing devices as discussed elsewhere herein. In some implementations, the memory 204 may store instructions and/or data that may he executed by the processor 202. For example, as depicted, the memory 204 may store the social network application 104, including a personalized descriptor engine. The memory 204 is also capable of storing other instructions and data, including, for example, an operating system, hardware drivers, other software applications, databases, etc. The memory 204 may be coupled to the bus 206 for communication with the processor 202 and the other components of social network server 102.

The memory 204 includes one or more non--transitory computer-usable (e.g., readable, writeable, etc.) mediums, which can be any tangible apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, an embedded memory device, a discrete memory device (e.g., a PROM, FPROM, ROM), a hard disk drive, an optical disk drive (CD, DVD, Blue-ray™, etc.). It should be understood that the memory 204 may be a single device or may include multiple types of devices and configurations.

The bus 206 can include a communication bus for transferring data between components of a computing device or between computing devices, a network bus system including the network 106 or portions thereof, a processor mesh, various connectors, a combination thereof, etc. In some implementations, the social network application 104 operating on the social network server 102 may cooperate and communicate with other components of the social network server 102 via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTPS connections, etc. Further, any or all of the communication could be secure (e.g., SSBI, HTTPS, etc.).

The communication unit 208 may include one or more interface devices for wired and/or wireless connectivity with the network 106 and the other entities and/or components of the system 100 including, for example, the third party server 108, the client devices 110, the social graph 118, the IM server 136, the micro-blogging server 134, the SMS/MMS server 132, etc. For instance, the communication unit 208 may include, but is not limited to, CAT-type interfaces; wireless transceivers for sending and receiving signals using Wi-Fi™; Bluetooth®, cellular communications, etc.; USB interfaces; various combinations thereof; etc. The communication unit 208 may be coupled to the network 106 via the signal line 122 and may be coupled to the other components of the social network server 102 via the bus 206. In some implementations, the communication unit 208 can link the processor 202 to the network 106, which may in turn be coupled to other processing systems. The communication unit 208 can provide other connections to the network 106 and to other entities of the system 100 using various standard communication protocols, including, for example, those discussed elsewhere herein.

The data store 210 is an information source for storing and providing access to data. In some implementations, the data store 210 may be coupled to the various components of the social network server 102 via the bus 206 to receive and provide access to data. In some implementations, the data store 210 may store data received from the other entities of the system 100, such as , the third party server 108, the client devices 110, the social graph 118, the IM server 136, the micro-blogging server 134, the SMS/MMS server 132, and provide data access to these entities. Examples of the types of data stored by the data store 210 may include, but are not limited to, a semantic database 212, document data, event data, entity data, user data, etc.

The data store 210 can include one or more non-transitory computer-readable mediums for storing the data. In some implementations, the data store 210 may be incorporated with the memory 204 or may be distinct therefrom. In some implementations, the data store 2.10 may include a database management system (DBMS) operable by the social network server 102. For example, the DBMS could include a structured query language (SQL) DBMS, a NoSQL, DMBS, various combinations thereof, etc. In some instances, the DBMS may store data in multi-dimensional tables comprised of rows and columns, and manipulate, i.e., insert, query, update and/or delete, rows of data using programmatic operations. Further, while shown as a component of the social network server 102, data store 210 may be distributed across one or more servers and access by the social network server 102 via network 106.

The personalized descriptor engine 220 includes software and/or logic executable by the processor 202 to generate personalized descriptors for use by the social network application 104 in creating a personalized input prompt. The personalized descriptor engine 220 may use elements of social network objects related to the user to generate personalized input prompts to encourage the user to engage in more activities related to the social network. Social network objects may include, for example, a user's profile, pictures, posts, replies to posts, tags, news articles, personal messages, etc.

In some implementations, the personalized descriptor engine 220 may analyze, for example, the interests listed in a user's profile and generate personalized descriptors based on the user's interests. The personal descriptors may then be used to create the personalized input prompt. For example, if a user's profile contains the statement “I love to ski,” the personalized descriptor engine may generate a personalized descriptor “skiing” that can be used in creating the personalized input prompt “Share what you love about skiing.”

In some implementations the personalized descriptor engine 220 may use semantic database 212 to generate intelligent personalized prompts based on sematic relationships between an element of a social network object related to the user and data stored in the semantic database 212. For example, if the user's profile contains an attribute relating to an education in meteorology, the system could prompt the user with the personalized input prompt “Share your thoughts on Hurricane Irene.” In this manner, the personalized descriptor engine 220 is better able to identify interests that are both accurate and at the right level of granularity, e.g. identifying “meteorology” rather than the too generic “science,” a common failure of pure inference systems.

In additional implementations, assuming a user opts-in, the personalized descriptor engine 220 may analyze data from other entities in the system 100 to generate personalized descriptors for use in creating the personalized input prompts. For example, the personalized descriptor engine 220 may analyze email, instant messages, flog posts, SMS or MMS messages, or other data related to the user.

FIG. 3 is a block diagram illustrating an example of a client device including a client device. As illustrated, client device 110 may include a processor 332, a memory 334, a communication unit 330, a data store 336, and a client application 112, which may be communicatively coupled by a communication bus 320. The client device 110 depicted in FIG. 3 is provided by way of example and it should be understood that it may take other forms and include additional or fewer components without departing from the scope of the present disclosure. For instance, various components of the client device 110 may reside on the same or different computing devices and may be coupled for communication using a variety of communication protocols and/or technologies including, for instance, communication buses, software communication mechanisms, computer networks, etc.

The network interface module 330 can transmit and receive data to and from the servers in the system 100. The network interface module 330 is coupled to a network, for example, network 106, by signal line :124 and coupled to the bus 320 via signal line 352. The network interface module may be similar to the communication unit 208 discussed above with reference to FIG. 2.

The processor 332 can comprise an arithmetic logic unit, a microprocessor, a general-purpose controller or some other processor array to perform computations and provide electronic display signals to a display device. The processor 332 may be coupled to the bus 320 via signal line 354 for communication with the other components. Processor 332 may be similar to processor 202 described above with reference to FIG. 2.

The memory 334 can store instructions and/or data that may be executed by processor 332. The memory 334 is coupled to the bus 320 via signal line 356 for communication with other components of the client device :110. The instructions and/or data stored by memory 334 may comprise code for performing any and/or all of the techniques described herein. The memory 334 may be similar to the memory 204 described above with reference to FIG. 2.

The data store 336 can be a non-transitory memory that stores data for the functionality of the client application 112. The data store 336 is coupled to the bus 320 via signal line 358 for communication with other components of the client device 110. The storage 336 may store information (for example, UI elements, social network content, etc.) received from other components of the system 100 and settings for a user 114 of the client device 110.

The client application 112 may include a controller 302 and a social network interface engine 304 that are each coupled to the bus 320. While the modules may be described in some examples as included in the client application 112, the modules may also be standalone applications, for example, as plug-ins to the client application 112 or components of a remote system, e.g., the social network application 104.

The controller 302 may include software and/or logic executable by the processor 332 for handling communications between the client application 112 and other components of the system 100. The controller 302 is adapted for cooperation and communication with the processor 332, the communication unit 330, the social network interface engine 304, and other components of the client device 110 via signal line 342.

The controller 302 may receive information via the communication unit 330 and provide the information to the appropriate component of the of the client application 112. For example, the controller 302 may receive information from the social network server 102 for rendering a social network interface on the client device 110. The controller 202 can also store the information in the data store 336. In another example, the controller 302 receives user inputs and user actions submitted by the user 114 from the client device 110. The controller 302 sends the user actions and the user inputs to the social network interface engine 304.

The controller 302 may also receive information from other components of the client application 112 and transmit the information to the appropriate server in the system 100 via the communication unit 330. For example, the controller 302 receives graphical data for generating a social network interface from the social network interface engine 304. The controller 202 transmits the graphical data to a display device (not shown) that is pail of the client device 110.

The social network interface engine 304 may include software and/or logic executable by the processor for generating graphical data for providing social network interfaces to the users 114. The social network interface engine 304 is adapted for cooperation and communication with the processor 332, the controller 302, and other components of the client device 110 via signal line 344.

The social network interface engine 304 can receive information from other components of the client device 110 or other entities of the system 100 via controller 302 for use in generating a social network interface for presentation to a user 114. For example, the social network interface engine 304 may receive interface instructions formatted using a markup language (e g., HTML, XML, etc.), style sheets (e.g., CSS, XSL, etc.), graphics, and/or scripts (e.g., JavaScript, ActionScript, etc.), and the social network interface engine 304 may interpret the interface instructions and render an interactive social network interface for display on client device 110 based thereon. In sonic implementations, the social network interface engine 304 may determine the formatting and look and feel of the social network interfaces independently. For instance, the social network interface engine 304 may receive a structured dataset (e.g., JSON, XML, etc.) including social network information (e.g., a personalized descriptor) for display and may determine formatting and/or look and feel of the social network interfaces client-side.

The social network interface engine 304 can also receive a user action on a visible user interface element from the controller 302. The term user action used herein encompasses its plain and ordinary meaning including, but not limited to any action performed by the user 114 using the social network interface provided to the user 114, for example, a status message post, a reply to a message, an indication of approval of a video, a request to mute a post, a request for reporting an e-mail as spam, etc.

In one example, the user action received by the social network interface engine 304 is a status message post. In this example, the social network interface engine 304 processes the user action by modifying the interactive social network interface to incorporate the status message posted by the user.

The social network interface engine 304 can process the user actions by using a Document Object Model (DOM). The DOM may define a logical structure for the social network interface. The DOM can he a cross-platform and language independent convention for accessing and interacting with the interactive elements of the social network interface. In these examples, the social network interface engine 304 uses the DOM, for example, for identifying the interactive interface element corresponding to the user action and converting it into a non-visible UI element.

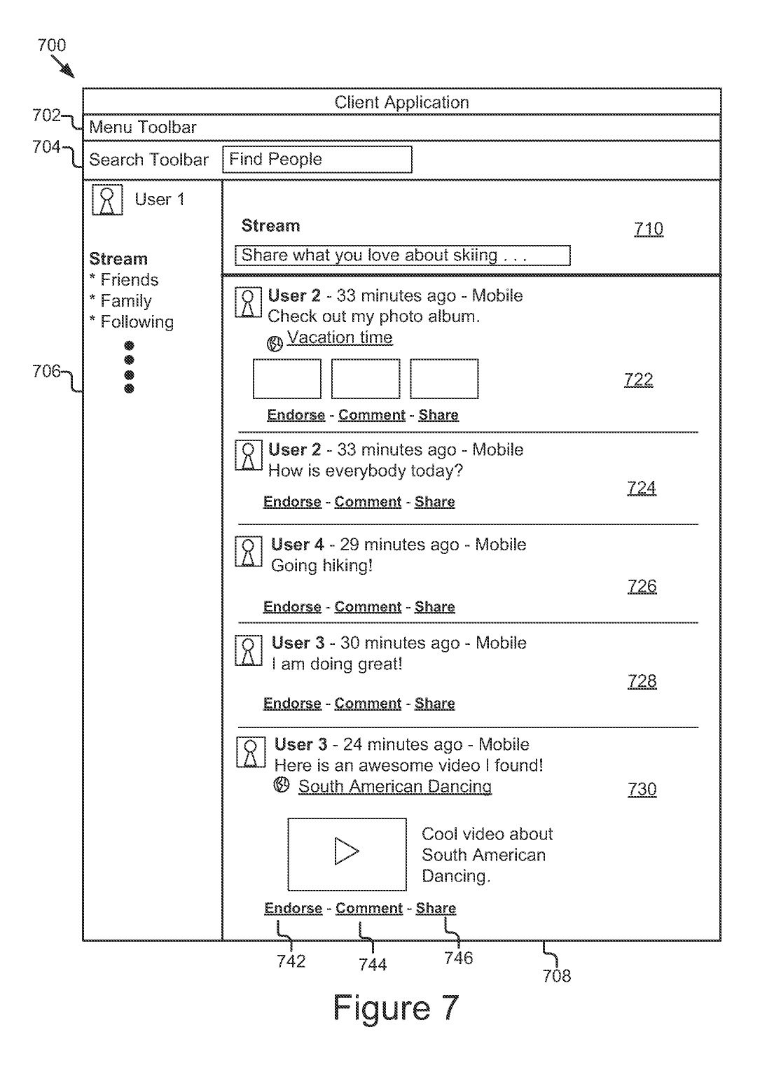

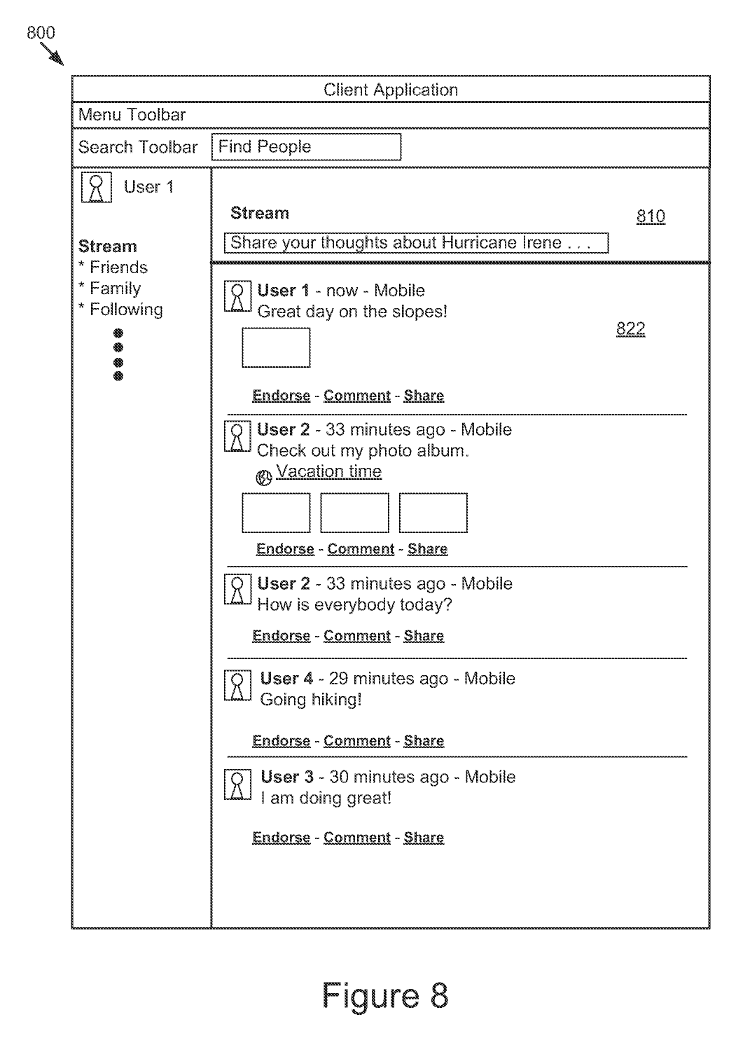

The social network interface engine 304 can receive user inputs from the controller 302. The term user input used herein encompasses its plain and ordinary meaning including, but not limited to an input submitted by the user 114 with reference to the display of the social network interface, i.e. the portion of the social network interface that is visible on the display. The user input includes scrolling the display of the social network interface, hiding the display of the social network interface (for example, minimizing a browser window i.e., a visual area displaying the social network interface), initiating a new social network interface (for example, initiating a new browser window for displaying a new social network interface, initiating a new tab in the browser window displaying the social network interface, switching to another tab in the browser window displaying the social network interface, etc.), refreshing the display of the social network interface, etc. The user interface engine 204 updates the graphical data in response to the received user input and sends a message to the on-page detector 206. The social network interfaces are explained below in further detail with reference to FIGS. 7-8.

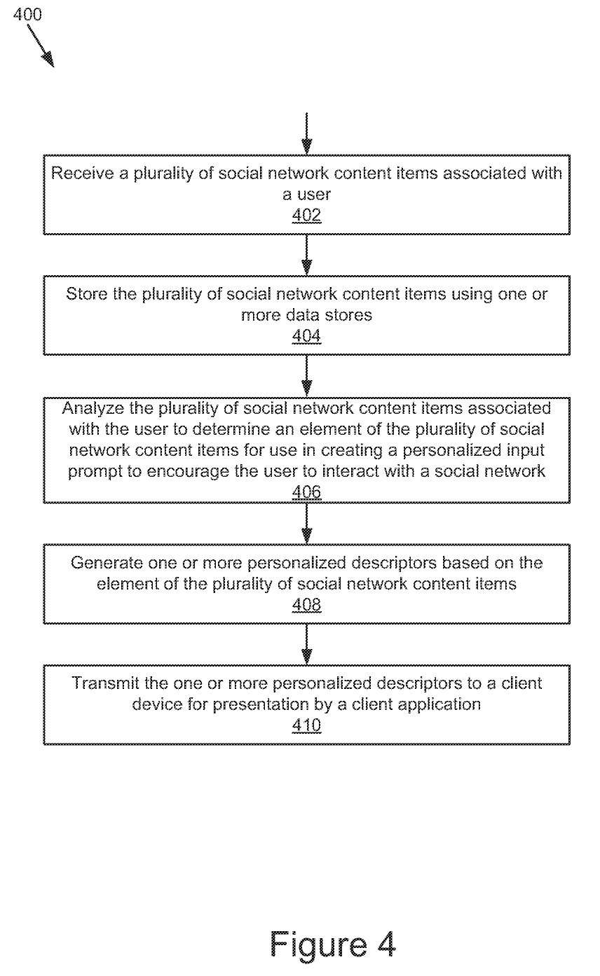

FIG. 4 is a flowchart depicting an example method 400 for presenting personalized input prompt to a user. The method begins at 402 where the social network server 102 receives a plurality of social network content items associated with a user. As described above, social network content items may include, for example, a user's profile, pictures, posts, replies to posts, tags, news articles, personal messages, etc.

At 404, the social network server 102 stores the plurality of social network content items in one or more data stores. At 406, the personalized descriptor engine 220 analyzes the plurality of social network content items associated with the user to determine an element of the plurality of social network content items for use in creating a personalized input prompt to encourage the user to interact with the social network. Additionally, assuming the user opts in, in some implementations the personalized descriptor engine 220 may analyze data from outside sources to provide determine an element of content items located outside of the social network for use in creating the personalized input prompt. For example, the personalized descriptor engine may analyze email, instant messages, SMS or MMS messages, other application data, calendar items, photos, etc. associated with the user.

At 408, the personalized descriptor engine 220 generates one or more personalized descriptors based on the element of the plurality of social network content items. The personalized descriptor may include, for example, a text string, an image, an object, etc. In one implementation, to generate the one or more personalized descriptors, the personalized descriptor engine 220 combines the element of the plurality of social network content items with additional information. For example, the element may be “skiing” as used in the examples above. The personalized descriptor engine 220 may combine the element “skiing” with a pre-determined string “Share what you love about . . . ” to create the personalized input prompt “Share what you love about skiing.”

At 410, the social network server 102 transmits the one or more personalized descriptors to a client device 110 for presentation to a user 114 by a client application 112. The social network server 102 may transmit the one or more personalized descriptors as a structured dataset (e.g., JSON, XML, etc.). In one implementation, the structured dataset may include the entire personalized input prompt. In another implementation, the structured dataset may include only the selected element and the client application combines the element with other appropriate elements of the markup language for rendering the personalized input prompt in the social network interface.

The process 400 may be repeated to generate one or more additional personalized descriptors based on one or more additional elements of the plurality of social network content items and transmitting the one or more additional personalized descriptors to the client device for presentation by the client application.

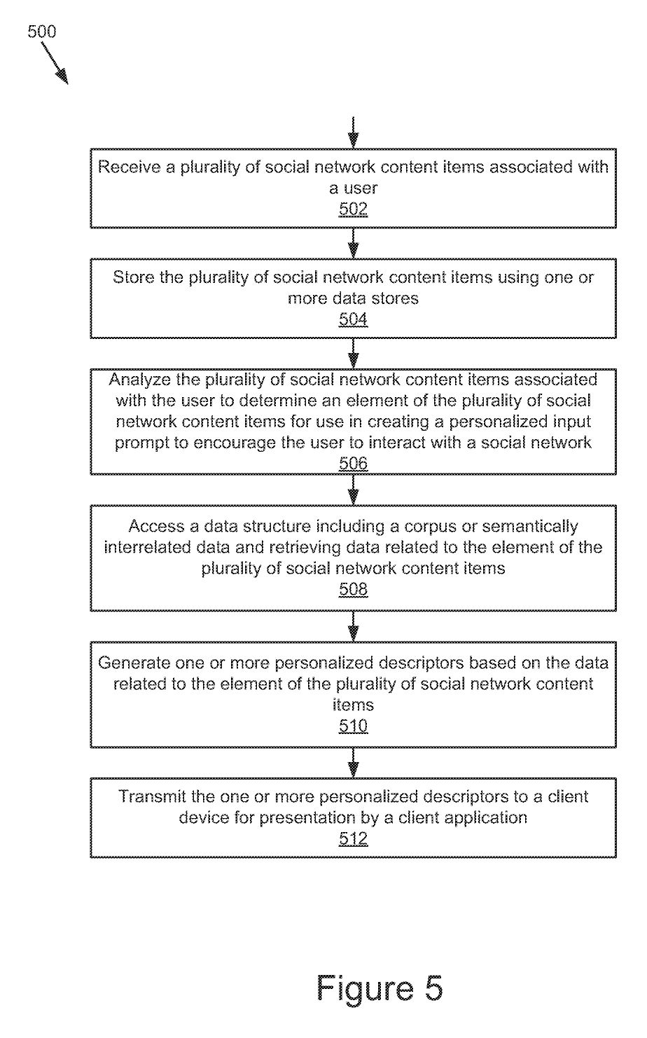

FIG. 5 is a flowchart depicting an example method 500 for presenting a personalized input prompt based on data semantically related to elements of social network objects associated with a user. The method begins at 502 where the social network server 102 receives a plurality of social network content items associated with a user. At 504, the social network server 102 stores the plurality of social network content items in one or more data. stores. At 506, the personalized descriptor engine 220 analyzes the plurality of social network content items associated with the user to determine an element of the plurality of social network content items for use in creating a personalized input prompt to encourage the user to interact with the social network.

At 508, the personalized descriptor engine 220 accesses a data structure including a corpus of semantically interrelated data and retrieves data related to the element of the plurality of social network content items. For example, as described above, the element “meteorology” may be used to retrieve various relevant topics from the data structure. Using the relevant topics, the personalized descriptor engine, at 510, generates one or more personalized descriptors based on the data related to the element of the plurality of social network content items. At 510, the social network server 102 transmits the one or more personalized descriptors to a client device 110 for presentation to a user 114 by a client application 112.

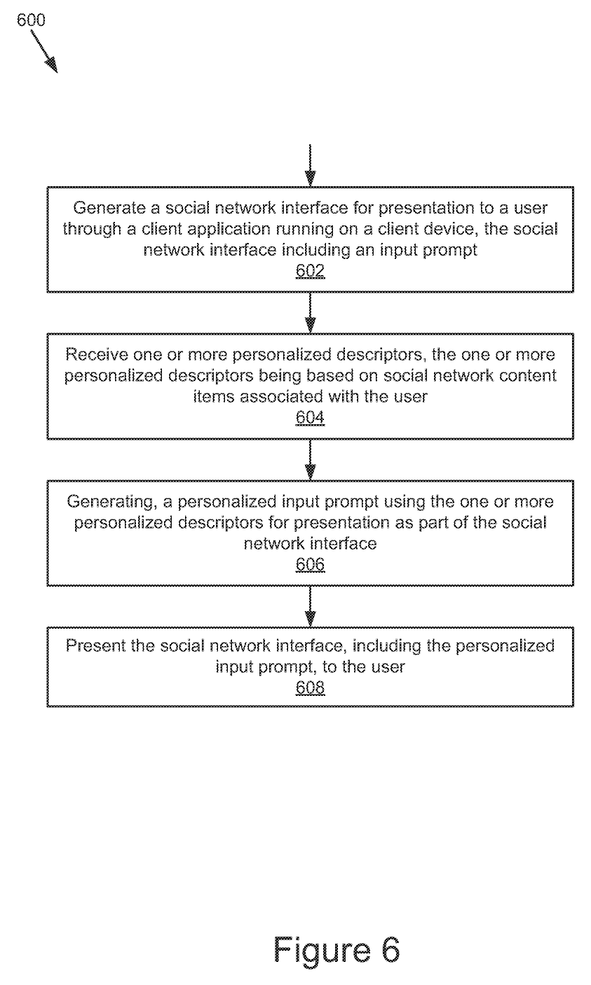

FIG. 6 is a flowchart depicting an example method 600 for presenting a personalized input prompt for display to a user on a client device. At 602, the social network interface engine 304 generates a social network interface for presentation to a user through a client application 112 running on a client device 110. In various implementations, the social network interface may include an input prompt to receive a post by a user. The social network interface engine 304 may receive interface instructions formatted using a markup language (e.g., HTML, XML etc.), style sheets (e.g., CSS, XSL, etc.), graphics, and/or scripts (e.g, JavaScript, ActionScript, etc.) from the social network server 102, and the social network interface engine 304 may interpret the interface instructions and render an interactive social network interface for display on client device 110.

At 604, in addition to, or included with, the interface instructions, the social network interface engine 304 receives one or more personalized descriptors. As described above in various implementations, the one or more personalized descriptors may be based on social network or other content associated with the user. In one implementation, the social network interface engine 304 generates the social network interface including a personalized input prompt for presentation at 608 to the user. In another implementation, for example, if the social network interface engine has already generated the social network interface, the social network interface may be updated to include the personalized input prompt.

FIG. 7 is an example graphic representation of a social network interface including a personalized input prompt. The social network interface 700 includes a number of interface elements such as a menu bar 702, a toolbar 704, a left sidebar 706, social network content 708, and input bar 710. Although not shown, the social network interface 700 may include various other interface elements of a conventional browser window, for example, an address bar, navigation buttons, multiple tabs, etc. Similarly, some of the interface elements shown in the social network interface 700 may be omitted in some implementations. The menu bar 702 provides the username of a user 114 and menus for accessing other systems, for example, email, calendar, etc. The toolbar 704 provides icons for accessing different functions of a social network and a search box for finding other users 1:14 of the social network. The left sidebar 706 provides hypertext links for requesting social network content and sending instant messages. The social network interface 700 may include other elements, such as a right sidebar that includes information about friends of the user 114, suggestions for the user 114 and other information about the social network. The social network content 708 includes posts 722, 724, 726, 728, and 730 submitted by the user's 114 friends to the social network server 102.

The user 114 may submit user actions on any of the above mentioned user interface elements. For example, the user 114 may click on the button 742 for submitting an indication of approval to the post 730. In another example, the user 1:14 may click on the links 744 and 746 for commenting on the post 730 and sharing the post 730, respectively. Additionally, user 114 may contribute ⁻to the social network by posting to the social network through the input bar 710. As depicted, the input bar 710 includes a personalized input prompt based on elements of social network as described above.

FIG. 8 is an example graphic representation of a social network interface after receiving an input based on a personalized input prompt. In this example, the user 114 submits a post in response to a personalized input prompt 710 depicted in FIG. 7. The social network interface engine 304 communicates the post to the social network server 102 and/or updates the social network interface to include the post 822 received from the user. In some implementations, the social network interface may he updated to present a new personalized input prompt in the input bar 810.

In the above description, for purposes of explanation, numerous specific details are set forth in order to provide a thorough understanding of the present disclosure. However, it should be understood that the technology described herein can he practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/0 devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IM P, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the present disclosure is not described with reference to any particular programming language. It will be appreciated that a variety of programming languages may be used to implement the teachings of the present disclosure as described herein.

The foregoing description has been presented for the purposes of illustration and description. It is not intended to be exhaustive or to limit the present disclosure to the precise form disclosed. Many modifications and variations are possible in light of the above teaching. It is intended that the scope of the disclosure be limited not by this detailed description, but rather by the claims of this application. As will be understood by those familiar with the art, the present disclosure may be embodied in other specific forms without departing from the spirit or essential characteristics thereof. Likewise, the particular naming and division of the modtiles, routines, features, attributes, methodologies and other aspects are not mandatory or significant, and the mechanisms that implement the present disclosure or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the present disclosure is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

1. A computer-implemented method comprising:
receiving, using one or more processors of a server, a plurality of social network content items associated with a user;
analyzing, using the one or more processors of the server, the plurality of social network content items associated with the user;
determining, using the one or more processors of the server, an interest of the user based on analyzing the plurality of social network content items;
performing, using the one or more processors of the server, a semantic inference based on the interest of the user;
determining, using the one or more processors of the server, a topic that is semantically related to the interest of the user based on the semantic inference;
generating, using the one or more processors of the server, a personalized descriptor of the interest of the user based on the topic;
generating, using the one or more processors of the server, a personalized input prompt by combining the personalized descriptor and a predetermined object, the personalized input prompt for prompting the user to engage in an activity relating to the interest of the user;
transmitting, using the one or more processors of the server, instructions executable by a client device, the instructions causing a client application on the client device to display to the user a social network interface including the personalized input prompt; and
responsive to the instructions causing the client application on the client device to display to the user the social network interface including the personalized input prompt, receiving, using the one or more processors of the server, from the user, the activity relating to the interest of the user.

2. The computer-implemented method of claim 1, wherein the activity relating to the interest of the user includes posting one or more photos, videos, profile information, replies, tags, personal messages, and news articles.

3. The computer-implemented method of claim 1, further comprising updating a social network profile associated with the user based on the activity.

4. The computer-implemented method of claim 1, further comprising storing the plurality of social network content items using one or more data stores, wherein the plurality of social network content items comprise at least one of a social network profile associated with the user, a social network post associated with the user, a social network post referencing the user, electronic mail associated with the user, and messages associated with the user.

5. (canceled)

6. The computer-implemented method of claim 1, wherein performing the semantic inference based on the interest of the user further comprises:
accessing a data structure including a corpus of semantically interrelated data;
retrieving data related to the interest of the user; and
generating the personalized descriptor based on the data related to the interest of the user.

7. The computer-implemented method of claim 1, further comprising repeatedly generating one or more additional personalized descriptors based on one or more additional interests of the user, and transmitting the instructions causing the client application on the client device to display to the user the one or more additional personalized descriptors.

8. The computer-implemented method of claim 1, wherein the predetermined object is one from a group of a text string and an image.

9. A computer program product comprising a non-transitory computer usable medium including a computer readable program, wherein the computer readable program when executed on a computer causes the computer to:
receive, at a server, a plurality of social network content items associated with a user;
analyze, by the server, the plurality of social network content items associated with the user;
determine, by the server, an interest of the user based on analyzing the plurality of social network content items;
perform, by the server, a semantic inference based on the interest of the user;
determine, by the server, a topic that is semantically related to the interest of the user based on the semantic inference;
generate, by the server, a personalized descriptor of the interest of the user based on the topic;
generate, by the server, a personalized input prompt by combining the personalized descriptor and a predetermined object, the personalized input prompt for prompting the user to engage in an activity relating to the interest of the user;
transmit, by the server, instructions executable by a client device to the client device, the instructions causing a client application on the client device to display to the user a social network interface including the personalized input prompt; and
responsive to the instructions causing the client application on the client device to display to the user the social network interface including the personalized input prompt, receive, by the server and from the user, the activity relating to the interest of the user.

10. The computer program product of claim 9, wherein the activity relating to the interest of the user includes posting one or more photos, videos, profile information, replies, tags, personal messages, and news articles.

11. The computer program product of claim [[10]] 9, wherein the computer readable program, when executed on the computer, further causes the computer to update a social network profile associated with the user based on the activity.

12. The computer program product of claim 9, wherein the computer readable program, when executed on the computer, further causes the computer to store the plurality of social network content items using one or more data stores, wherein the plurality of social network content items comprise at least one of a social network profile associated with the user, a social network post associated with the user, a social network post referencing the user, electronic mail associated with the user, and messages associated with the user.

13. (canceled)

14. The computer program product of claim 9, wherein performing the semantic inference based on the interest of the user further comprises:
accessing a data structure including a corpus of semantically interrelated data;
retrieving data related to the interest of the user; and
generating the personalized descriptor based on the data related to the interest of the user.

15. The computer program product of claim 9, wherein the computer readable program, when executed on the computer, further causes the computer to repeatedly generate one or more additional personalized descriptors based on one or more additional interests of the user, and transmit the instructions causing the client application on the client device to display to the user the one or more additional personalized descriptors.

16. The computer program product of claim 9, wherein the predetermined object is one from a group of a text string and an image.

17. A system comprising:
a processor;
a memory storing instructions that, when executed by the processor, cause the system to:
receive, at a server, a plurality of social network content items associated with a user;
analyze, by the server, the plurality of social network content items associated with the user;
determine, by the server, an interest of the user based on analyzing the plurality of social network content items;
perform, by the server, a semantic inference based on the interest of the user;
determine, by the server, a topic that is semantically related to the interest of the user based on the semantic inference;
generate, by the server, a personalized descriptor of the interest of the user based on the topic;
generate, by the server, a personalized input prompt by combining the personalized descriptor and a predetermined object, the personalized input prompt for prompting the user to engage in an activity relating to the interest of the user;
transmit, by the server, instructions executable by a client device to the client device, the instructions causing a client application on the client device to display to the user a social network interface including the personalized input prompt; and
responsive to the instructions causing the client application on the client device to display to the user the social network interface including the personalized input prompt, receive, by the server and from the user, the activity relating to the interest of the user.

18. The system of claim 17, wherein the activity relating to the interest of the user includes posting one or more photos, videos, profile information, replies, tags, personal messages, and news articles.

19. The system of claim [[18]] 16, wherein the instructions, when executed, further cause the system to update a social network profile associated with the user based on the activity.

20. The system of claim 17, wherein the instructions, when executed, further cause the system to store the plurality of social network content items using one or more data stores, wherein the plurality of social network content items comprise at least one of a social network profile associated with the user, a social network post associated with the user, and/or a social network post referencing the user, electronic mail associated with the user, and messages associated with the user.

21. (canceled)

22. The system of claim 17, wherein to perform the semantic inference based on the interest of the user, the instructions further cause the system to:
access a data structure including a corpus of semantically interrelated data;
retrieve data related to the interest of the user; and
generate the personalized descriptor based on the data related to the interest of the user.

23. The system of claim 17, wherein the instructions, when executed, further cause the system to repeatedly generate one or more additional personalized descriptors based on one or more additional interests of the user, and transmit the instructions causing the client application on the client device to display to the user the one or more additional personalized descriptors.

24. The system of claim 17, wherein the predetermined object is one from a group of a text string and an image.

25. A computer-implemented method comprising:
generating, by one or more processors, a social network interface for presentation to a user through a client application running on the client device, the social network interface including an input prompt;
determining, by the one or more processors, an interest of the user based on social network content items associated with the user;
performing, by the one or more processors, a semantic inference based on the interest of the user;
determining, by the one or more processors, a topic that is semantically related to the interest of the user based on the semantic inference;
generating, by the one or more processors, one or more personalized descriptors of the interest of the user based on the topic;
generating, by the one or more processors, a personalized input prompt using by combining the one or more personalized descriptors and a predetermined object for presentation as part of the social network interface, the personalized input prompt for prompting the user to engage in an activity relating to the interest of the user;
transmitting, by the one or more processors, instructions to the client device of the user, the instructions executable by the client device to cause a display of the social network interface including the personalized input prompt to the user; and
receiving, by the one or more processors, from the user, the activity relating to the interest of the user in response to the personalized input prompt.

26. (canceled)
